(19) United States
(12) Patent Application Publication
(10) Pub. No.: US 2002/0116536 A1
(43) Pub. Date: Aug. 22, 2002

(54) Method and communication device for supporting various CSTA phases

(76) Inventors: Freddy De Clercq, Oostkamp (BE); Claus Rist, Bochum (DE)

Correspondence Address: BELL, BOYD & LLOYD, LLC, P. O. BOX 1135, CHICAGO, IL, 60690-1135, US

(21) Appl. No.: 09/953,117

(22) Filed: Sep. 10, 2001

(30) Foreign Application Priority Data
Sep. 8, 2000 (DE) 10044417.2

(51) Int. Cl. G06F 15/16

(52) U.S. Cl. 709/250

(57) ABSTRACT

A communication system and method are provided for generating a message which is exchanged between a communication device and a CSTA application via a CSTA interface. The message is created including a first message part assigned to a first CSTA phase, and a second message part assigned to a second CSTA phase.

### BACKGROUND OF INVENTION

The invention relates to a communication device and method for transmitting information via a CSTA interface.

Computer Supported Telecommunication Application, or CSTA for short, is an interface for coupling data-processing devices, for example personal computers PC, and communication devices, for example telephones. CSTA represents a standard by which a message structure or a message type is defined for an exchange of messages between a data-processing device and a communication device in which various communication-specific features, such as for example alternating between lines, call forwarding, conference calls and the like are realized.

According to the standards ECMA-217, ECMA-218, ECMA-269 and ECMA-285, a distinction is drawn between various versions of CSTA. Hereafter, the different versions will be referred to as CSTA phase II and CSTA phase III.

To ensure the functionality of a CSTA application, it may be necessary for the CSTA application to receive information regarding communication-device-specific statuses and connections. Therefore, some or all of the communication devices relevant to the CSTA application (referred to in the literature as CSTA objects) must be monitored. In the event of a change in status of a monitored CSTA object, for example a communication terminal, a message known as a call event report is generated and transmitted to the CSTA application. The call event report indicates the cause of the change in status. More details regarding call event reports may be found in ECMA-208, Section 10.1 and Section 17; ECMA-217 Section 11.2.3 and ECMA-269, Section 17.2, the teachings of which are incorporated herein by reference.

In the example of a change in the status of a communication terminal, the call event report may contain a connection identification, which identifies the CSTA objects involved in the event. However, other parameters may also be used to identify relevant objects.

Events or changes in the status of devices may be initiated by the interaction of a call with other connection functions. In a call event report, parts which may have different values, depending on the CSTA phase, correspond to such connection functions and their activation.

In general, call event reports indicate changes in relevant connection statuses. An exception to this rule is a waiting loop. It is possible that a call that is in a waiting loop may be brought forward without leaving the waiting loop. Though the status does not change, a call event report is generated each time the call advances. Call event reports may furthermore relate to an individual connection, to a number of connections in one call, or to a number of connections in a number of calls.

Generally, a call event report indicates that the end status of a CSTA object has been reached, irrespective of the previous statuses. Initial statuses are only indicated to put the call event report into a general telecommunication context.

When call event reports are sent within a CSTA application, it may happen that the call event report of a CSTA phase differs formally from the call event report of another CSTA phase, although the call event reports describe an identical change in status. This is a problem because known CSTA applications only support one CSTA phase. As a result, known CSTA applications can only understand the call event reports of the CSTA phase which they support. This practice leads to a great restriction on the use of CSTA applications.

### SUMMARY OF THE INVENTION

The present invention is based on the object of specifying measures which make it possible for CSTA applications to be used independently of the various CSTA phases.

According to a first aspect of the invention, a method for generating a message which is exchanged between a communication device and a CSTA application via a CSTA interface is provided. The method includes the steps creating a first message part assigned to a first CSTA phase, and creating a second message part assigned to a second, different CSTA phase. Preferably, the generated message serves to set up and administer connections with the communication device. Further, the message may be generated as a call event report. According to this aspect of the invention, it is also preferred that the first and second parts of the generated message relate to the same events, and that the two parts are linked by a logical “Or.” However, if the first and second parts are found to be formally identical, the parts are to be linked by a logical “And.”

In another aspect of the invention, the generated message includes a field having at least one cell into which the first and second message parts are written. A communication device is provided which is connected with a CSTA application via a CSTA interface. At least one message is exchanged between the communication device and the CSTA application via the CSTA interface. According to the invention, the communication device is set up for generating the message in at least two parts. The first part is assigned to a first CSTA phase, for example, CSTA phase II and the second part is assigned to a second CSTA phase, for example CSTA phase III.

This solution allows the realization of CSTA applications which support different CSTA phases. A further advantage of the invention is that it allows new CSTA versions or phases to be adapted in a simple way to existing CSTA applications. If current operating statuses of communication terminals of a communication system are to be transmitted to a CSTA application, the message is advantageously generated as a call event report. Preferably the communication device is adapted to generate the message in the form of a field which has at least one cell wherein the at least two parts are being written into at least one cell.

It is also preferred that the at least two message parts are assigned to the same event. Further, the parts may be advantageously linked by a logical ‘Or’. However, in an embodiment of the invention, a check is carried out to ascertain whether the generated message parts are formally identical and, in the case of formal identity, the parts are linked by a logical ‘And’.

Particularly suitable for realizing the method according to the invention is a communication device or a communication system which is set up for generating a message comprising at least two parts which are assigned to different CSTA phases. The invention, together with further advantages, is explained in more detail below on the basis of several non-restrictive exemplary embodiments, which are illustrated in the drawing.

### BRIEF DESCRIPTION OF THE DRAWINGS

FIG. 1 is a schematic representation of a communication system according to the invention;

FIG. 2 is a schematic representation of a call event report according to the prior art;

FIG. 3 is a schematic representation of a call event report of CSTA phase II according to the prior art;

FIG. 4 is a schematic representation of a call event report of CSTA phase III according to the prior art; and

FIG. 5 is a schematic representation of a call event report according to the invention.

### DETAILED DESCRIPTION OF THE INVENTION

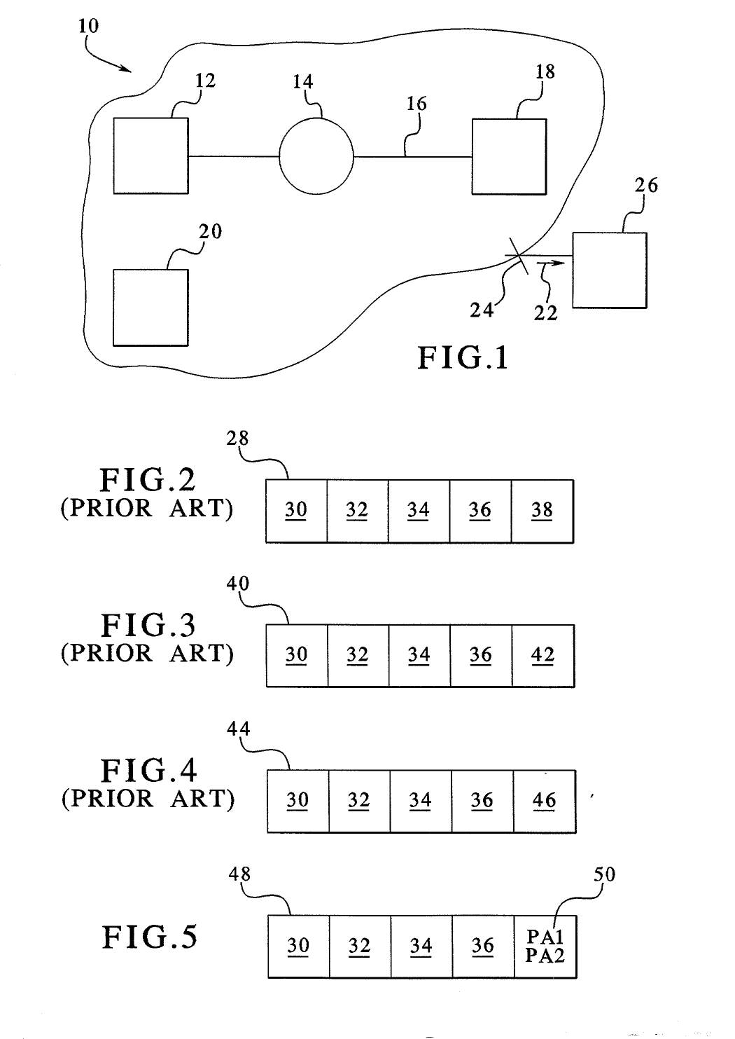

FIG. 1 shows a schematic representation of a communication system 10 according to the present invention. The system is shown having a CSTA interface 22 with respect to a CSTA application 26. The communication system 10 comprises various CSTA objects, for example, a first communication terminal 12, which accepts a call 16 from a second communication terminal 18. The call 16 can be forwarded to a third communication terminal 20. A switching function 14 is provided for switching the call 16 within the communication system 10.

According to the present invention, in order to provide the CSTA application ANW with relevant information concerning the current connection statuses of the communication terminals 12, 18, 20, a message 24 is created for each of the communication terminals 12, 18, 20. The messages are created in the form of call event reports. Thus, a call event report is created by the communication system SYS for each CSTA object. Messages are transmitted to the CSTA application 26 via the CSTA interface 22.

As shown in FIG. 2, a call event report 28 for one of the communication terminals 12, 18, 20, according to the prior art may take the form of a field made up of a number of cells 30, 32, 34, 36, 38. Parameters characterizing the status of the respective communication terminal 12, 18, 20 are inserted into the cells 30-38.

The first cell 30 may contain, for example, the last connection of the communication terminal 12, 18, 20 considered, the second cell 32 may contain an identification of the communication terminal 12, 18, 20 from which the call was forwarded, the third cell 34 may contain an identification for the communication terminal 12, 18, 20 to which the call was forwarded, the fourth cell 36 may contain the status of the local connection of the communication terminal 12, 18, 24 considered and the fifth cell 38 may contain the cause of the current connection status.

As already mentioned at the outset, different CSTA phases may generate call event reports 28 of a different form. FIG. 3 shows a schematic representation of a call event report 40 according to CSTA phase II. In this case, the cell 42, in which the cause of the current connection status is indicated, contains a part PA1. FIG. 4 shows a schematic representation of a call event report 44 according to CSTA phase III. In this case, the cell 46, in which the cause of the current connection status is likewise indicated, contains a part PA2. The part PAM according to the call event report 40 for CSTA phase II of FIG. 3 differs formally from the corresponding part PA2 in the call event report 44 for CSTA phase III of FIG. 4. Consequently, the comprehensibility of these call event reports 40, 44 is phase-dependent. The call event reports displayed in FIGS. 3 and 4 can be understood only by CSTA applications which support CSTA phase II or CSTA phase III, respectively.

For example, the part PA1 according to CSTA phase II, which is entered in the cell 42 for the cause of the current connection status, comprises the value “busy” if a connection setup with the relevant communication terminal 12, 18, 20 is not possible at the time. According to CSTA phase III, the part PA2, which is entered in the cell 46 which describes the same situation, comprises the value “not reachable”.

FIG. 5 shows a schematic representation of a call event report 48 according to the present invention. In this case, the cell 50, which supports both CSTA phase II and CSTA phase III, contains two parts, PA1, PA2, with identical information, each CSTA phase being assigned one of the parts PA1, PA2. The two parameters PA1, PA2 may be linked by a logical “Or”, in order that, the CSTA application 26 may perform a logical “Or inquiry.” Thus, the CSTA application 26 may select part PA1 or PA2 according to the proper CSTA phase so that the CSTA application can read the parameter PA1 or PA2. The call event report 48 according to the invention for the situation described in FIG. 3 and FIG. 4 therefore has a status message of the form “busy Or not reachable” in the cell 50 for the cause of the current connection status. In the case when the two parts PA1, PA2 are also formally identical, they may also be connected by a logical ‘And’.

It should be understood that various changes and modifications to the presently preferred embodiments described herein will be apparent to those skilled in the art. Such changes and modifications can be made without departing from the spirit of and scope of the present invention and without diminishing its attended advantages. It is therefore intended that such changes and modifications be covered by the hereafter appended claims.

1. A method for generating a message which is exchanged between a communication device and a CSTA application via a CSTA interface (SST), the method comprising:
creating a first message part assigned to a first CSTA phase; and
creating a second message part assigned to a second CSTA phase.

2. The method as claimed in claim 1, wherein the generated messaged is provided for the setting up and administrating the connections with the communication device.

3. The method as claimed in claim 2, wherein the generated message is generated as a call event report (REB).

4. The method as claimed in claims 3, wherein the generated message is generated in the form of a field having at least one cell and wherein the first message part and the second message part are written into one of said at least one cells.

5. The method as claimed in claim 4, wherein the first message part and the second message part are assigned to the same event.

6. The method as claimed in claim 5, further comprising the step of linking said first message part and said second message part by a logical “or.”

7. The method as claimed in claim 6, further comprising the step of checking to determine whether the first message part and the second message part are formally identical and, in the case of formal identity, the method further comprising the step of linking said first message part and said second message part by a logical “And.”

8. The method as claimed in claim 1, wherein the generated message is generated as a call event report (REB).

9. The method as claimed in claim 1, wherein the generated message is generated in the form of a field having at least one cell and wherein the first message part and the second message part are written into one of said at least one cells.

10. The method as claimed in claim 1, wherein the first message part and the second message part are assigned to the same event.

11. The method as claimed in claim 1, further comprising the step of linking said first message part and said second message part by a logical “Or.”

12. The method as claimed in claim 1, further comprising the step of checking to determine whether the first message part and the second message part are formally identical and, in the case of formal identity, the method further comprising the step of linking said first message part and said second message part by a logical “And.”

13. A communication system comprising:
a CSTA application;
a CSTA interface; and
a communication device configured to generate at least one message to be exchanged between the communication device and the CSTA application via the CSTA interface, the message including a first part assigned to a first CSTA page and a second part assigned to a second CSTA phase.

14. The communication system as claimed in claim 8 wherein at least one message generated by the communication device is adapted for the setting up and administration of connections with the communication device.

15. The communication system as claimed in claim 13 wherein the communication device is configured for generating the message as a call event report.

16. The communication system as claimed in claim 13 wherein the communication device is configured to generate the message as a field having at least one cell and wherein the first and second message parts are arranged in at least one said cell.

17. The communication system as claimed in claim 13 wherein the communication device is configured to generate said first and second parts of at least one message are assigned to a common event.

18. The communication system as claimed in claim 13 wherein the communication device is configured to link the first and second message parts by a logical “Or.”

19. The communication system as claimed in claim 13 wherein the communication device is configured to ascertain whether the first and second message parts are formally identical and, in the case of formal identity, to link said first and second parts by a logical “And”.

20. The communication system as claimed in claim 14 wherein the communication device is configured for generating the message as a call event report.

21. The communication system as claimed in claim 15 wherein the communication device is configured to generate the message as a field having at least one cell and wherein the first and second message parts are arranged in at least one said cell.

22. The communication system as claimed in claim 16 wherein the communication device is configured to generate said first and second parts of at least one message are assigned to a common event.

23. The communication system as claimed in claim 17 wherein the communication device is configured to link the first and second message parts by a logical Or.

24. The communication system as claimed in claim 18 wherein the communication device is configured to ascertain whether the first and second message parts are formally identical and, in the case of formal identity, to link said first and second parts by a logical And.
